(19) United States
(12) Patent Application Publication
(10) Pub. No.: US 2026/0213656 A1
(43) Pub. Date: Jul. 23, 2026

(54) VOLTAGE CONVERSION DEVICE AND METHOD

(71) Applicant: NUVOTON TECHNOLOGY CORPORATION, HSINCHU CITY (TW)

(72) Inventor: Chun-Ku LIN, Zhubei City (TW)

(21) Appl. No.: 19/375,529

(22) Filed: Oct. 31, 2025

(30) Foreign Application Priority Data
Jan. 23, 2025 (TW) 114103093

(51) Int. Cl. H02M 3/07

(52) U.S. Cl. CPC H02M 3/07

(57) ABSTRACT

A voltage conversion device and a method capable of adjusting a voltage conversion rate based on an input voltage are provided. The voltage conversion device includes a charge pump circuit, an operating voltage generation module, and a processing module. The charge pump circuit converts the input voltage into an output voltage based on an operating voltage and a clock signal, and the voltage conversion rate of the charge pump circuit is dynamically adjustable. The operating voltage generation module is connected to the output voltage, includes a Zener diode, and generates the operating voltage based on a conduction state of the Zener diode. The processing module is connected to the operating voltage generation module, detects a first current flowing through the Zener diode, and adjusts the voltage conversion rate of the charge pump circuit based on the first current.

### CROSS-REFERENCE TO RELATED APPLICATION

This application claims the priority from the Taiwanese Patent Application No. 114103093, filed on Jan. 23, 2023, and all contents of such Taiwanese Patent Application are comprised in the present disclosure.

### BACKGROUND

### 1. Field of the Invention

The present invention relates to a voltage conversion device technology, and more particularly, to a voltage conversion device and method capable of adjusting a voltage conversion rate based on an input voltage.

### 2. Description of the Related Art

The purpose of a voltage conversion device is to convert an input voltage into an output voltage at a predetermined conversion rate, wherein the predetermined conversion rate can be a conversion rate higher than 1 or a conversion rate less than 1. Common voltage conversion devices include charge pump devices and switch capacitor power conversion devices.

As the application of voltage conversion devices becomes increasingly widespread, the input voltage of a voltage conversion device may have a wide voltage range from 2.8V to 20V. For example, after the system in which the voltage conversion device is located is powered on, the input voltage gradually increases from 0 to a target value, it causes an output voltage of the voltage conversion device to undergo a large variation and fail to remain within a predetermined range, thereby impacting the overall system performance.

In view of the foregoing, there is a need for a voltage conversion device and method capable of adjusting a voltage conversion rate based on an input voltage to reduce the variation in the output voltage of the voltage conversion device.

### SUMMARY

In view of the above-described issues, the present invention aims to provide a voltage conversion device and a method thereof.

To achieve the foregoing objective, the present invention discloses a voltage conversion device comprising a voltage conversion circuit, an operating voltage generation module, and a processing module. The voltage conversion circuit converts an input voltage into an output voltage based on an operating voltage and a clock signal, wherein a voltage conversion ratio of the voltage conversion circuit is dynamically adjustable. The operating voltage generation module comprises a Zener diode and generates the operating voltage based on the input voltage and a conduction state of the Zener diode. The processing module is connected to the operating voltage generation module, and detects a first current flowing through the Zener diode and adjusts the voltage conversion ratio of the voltage conversion circuit based on the first current.

According to one embodiment, when the first current is greater than a reference current, the processing module sets the voltage conversion ratio of the voltage conversion circuit to a lower value.

According to another embodiment, when the first current is not greater than the reference current, the processing module sets the voltage conversion ratio of the voltage conversion circuit to a higher value.

According to one embodiment, the processing module comprises a current mirror circuit and a reference current source. The reference current source is configured to generate a reference current. A first end of the current mirror circuit is coupled to a Zener diode, such that a first current flows through the first end. A second end of the current mirror circuit is coupled to the reference current source. The current mirror circuit mirrors the first current to generate a second current flowing through the second end. A voltage at the second end is used to set the voltage conversion ratio of the voltage conversion circuit.

According to one embodiment, the voltage conversion circuit comprises a charge pump circuit, and the charge pump circuit comprises charge pump stages connected in series. The processing module comprises a switch and a logic circuit. The switch is connected in parallel with one of the charge pump stages. The logic circuit is configured to selectively turn on the switch to bypass the one of the charge pump stages, thereby adjusting the voltage conversion ratio of the charge pump circuit.

According to one embodiment, reference currents are provided, the processing module performs multi-level adjustment of the voltage conversion ratio of the voltage conversion circuit based on whether the first current is respectively greater than the reference currents.

To achieve the foregoing objective, the present invention discloses a voltage conversion method comprising the following steps. A voltage conversion circuit is provided. The voltage conversion circuit converts an input voltage into an output voltage based on an operating voltage and a clock signal, wherein a voltage conversion ratio of the voltage conversion circuit is dynamically adjustable. An operating voltage generation module is provided. The operating voltage generation module comprises a Zener diode and generates the operating voltage based on the input voltage and a conduction state of the Zener diode. A first current flowing through the Zener diode is detected, and the voltage conversion ratio of the voltage conversion circuit is adjusted based on the first current.

According to an embodiment, adjusting the voltage conversion ratio of the voltage conversion circuit based on the first current comprises: when the first current is greater than a reference current, setting the voltage conversion ratio of the voltage conversion circuit to a lower value; and when the first current is not greater than the reference current, setting the voltage conversion ratio of the voltage conversion circuit to a higher value.

According to an embodiment, the voltage conversion method further comprises: providing a reference current source configured to generate a reference current; and providing a current mirror circuit, wherein a first end of the current mirror circuit is coupled to the Zener diode such that the first current flows through the first end, and a second end of the current mirror circuit is coupled to the reference current source. The current mirror circuit mirrors the first current to generate a second current flowing through the second end. The voltage at the second end of the current mirror circuit is used to adjust the voltage conversion ratio of the voltage conversion circuit.

According to an embodiment, the voltage conversion circuit comprises a charge pump circuit, and the charge pump circuit comprises charge pump stages connected in series, and the voltage conversion method further comprises: providing a switch connected in parallel with one of the charge pump stages; and selectively turning on the switch to bypass the one of the charge pump stage based on whether the first current is greater than the reference current, thereby adjusting the voltage conversion ratio of the charge pump circuit.

According to the above technical solution, the present invention enables the voltage conversion device to adjust the voltage conversion ratio based on the input voltage, thereby reducing the variation range of the output voltage of the voltage conversion device.

### BRIEF DESCRIPTION OF THE DRAWINGS

FIG. 1 is a block diagram of a voltage conversion device according to the present invention.

FIG. 2 is a circuit diagram of an embodiment of a voltage conversion device according to the present invention.

FIG. 3 is a flowchart of a voltage conversion method according to the present invention.

FIG. 4 is a flowchart of an embodiment of a voltage conversion method according to the present invention.

### DESCRIPTION OF THE PREFERRED EMBODIMENTS

The following detailed description, along with the accompanying drawings and exemplary embodiments, provides a comprehensive understanding of how the present invention applies technical means to address technical issues and achieve the intended technical effects.

To make the features and advantages of the present disclosure more apparent, the following provides a detailed description of specific embodiments in conjunction with the accompanying drawings. The descriptions herein contain specific information related to exemplary embodiments. The drawings and detailed descriptions provided herein are intended solely as examples. However, the present disclosure is not limited to these exemplary embodiments, and those skilled in the art may conceive of other variations and implementations based on this disclosure. Unless otherwise specified, elements in the drawings that are the same or corresponding may be indicated by identical or corresponding reference numerals. Additionally, the drawings and illustrations in this disclosure are not necessarily drawn to scale and are not intended to correspond to actual relative dimensions.

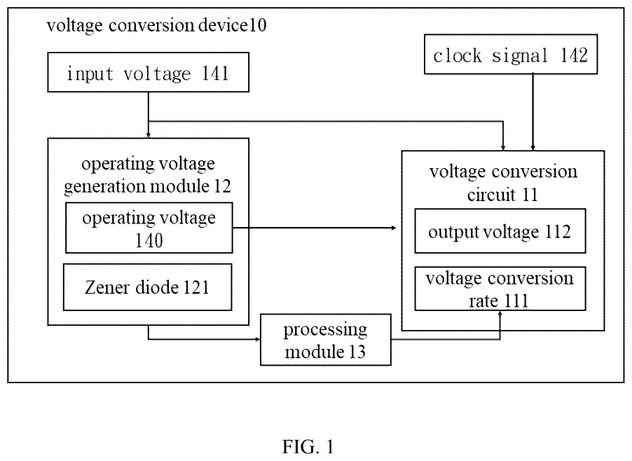

Referring to FIG. 1, FIG. 1 is a block diagram of the voltage conversion device according to the present invention. As shown in FIG. 1, the voltage conversion device 10 comprises a voltage conversion circuit 11, an operating voltage generation module 12, and a processing module 13. The voltage conversion circuit 11 converts an input voltage 141 into an output voltage 112 based on an operating voltage 140 and a clock signal 142, and the voltage conversion rate 111 of the voltage conversion circuit 11 is dynamically adjustable. The operating voltage generation module 12 comprises a Zener diode 121 and generates the operating voltage 140 based on the input voltage 141 and the conduction state of the Zener diode 121. The processing module 13 is connected to the operating voltage generation module 12 and is configured to detect a current flowing through the Zener diode 121 and adjust the voltage conversion rate 111 of the voltage conversion circuit 11 based on the detected current.

In one embodiment, when the current flowing through the Zener diode 121 is higher than a reference current, the Zener diode 121 is conducted, the processing module 13 sets the voltage conversion rate 111 of the voltage conversion circuit 11 to a lower value. When the current flowing through the Zener diode 121 is not higher than the reference current, the Zener diode 121 is not conducted, the processing module 13 sets the voltage conversion rate 111 of the voltage conversion circuit 11 to a higher value. For example, during the process in which the input voltage 141 gradually increases from 0, when the Zener diode 121 is not conducted, the Zener diode 121 does not enter the breakdown state, the operating voltage 140 increases along with the input voltage 141. The operating voltage 140 is relatively low in this phase, so the voltage conversion circuit 11 requires a higher voltage conversion rate 111 to maintain the output voltage within a predetermined range. The processing module 13 sets the voltage conversion rate 111 of the voltage conversion circuit 11 to a higher value. For example, in a condition that the voltage conversion rate 111 of the voltage conversion circuit 11 can be set to either 2 or 3, when the current flowing through the Zener diode 121 is not higher than the reference current, the processing module 13 sets the voltage conversion rate 111 to 3.

When the input voltage 141 increases to a level where the Zener diode 121 enters the breakdown state and is conducted, the operating voltage 140 is clamped by the breakdown voltage of the Zener diode 121. The operating voltage 140 is relatively high in this phase, so the voltage conversion circuit 11 requires a lower voltage conversion rate 111 to maintain the output voltage 112 within a predetermined range. The processing module 13 sets the voltage conversion rate 111 of the voltage conversion circuit 11 to a lower value, such as 2.

In an embodiment, the voltage conversion circuit 11 can be a charge pump circuit or a switched capacitor power conversion circuit.

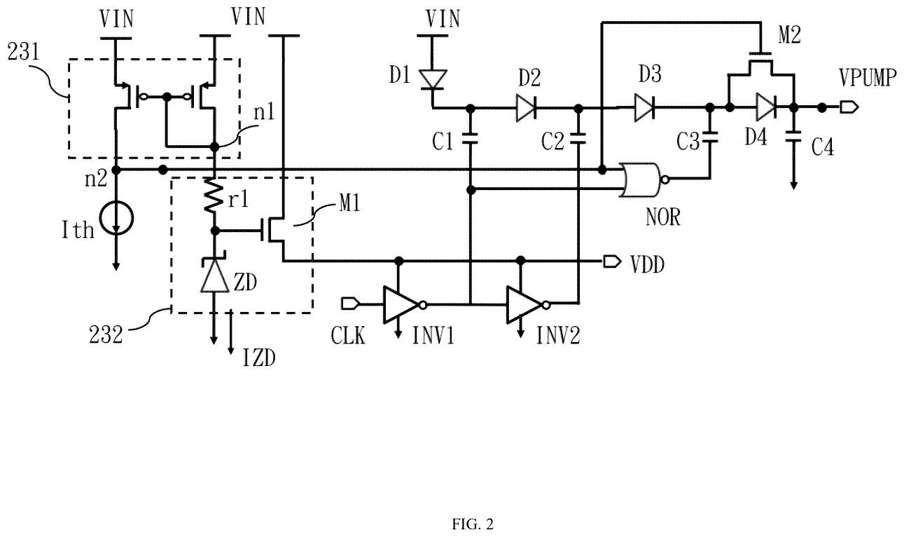

Referring to FIG. 2, FIG. 2 is a circuit diagram of an embodiment of the voltage conversion device according to the present invention. As shown in FIG. 2, the voltage conversion device comprises a charge pump circuit, an operating voltage generation circuit 232, a current mirror circuit 231, a reference current source Ith, and a selection circuit. It should be noted that in this embodiment, a Dickson charge pump circuit is used to implement the voltage conversion circuit. However, the present invention is not limited to this implementation. The processing module 13 in FIG. 1 is implemented using the current mirror circuit 231, the reference current source Ith, and the selection circuit. The selection circuit includes a NOR logic gate and a switch. In this embodiment, the switch is implemented by a transistor M2.

The charge pump circuit in FIG. 2 comprises charge pump stages connected in series and inverters INV1 and INV2 connected in series. Each charge pump stage comprises a diode and a capacitor. The inverters INV1 and INV2 operate based on the operating voltage VDD. An input end of the inverter INV1 receives a clock signal CLK. Diodes D1 to D4 are connected in series. An anode of the diode D1 receives the input voltage VIN. A capacitor C1 is connected between a cathode of the diode D1 and an output end of the inverter INV1. A capacitor C2 is connected between a cathode of the diode D2 and an output end of inverter INV2. A capacitor C3 is connected between a cathode of diode D3 and an output end of the NOR logic gate. A capacitor C4 is connected between a cathode of the diode D4 and ground. A voltage at the cathode of the diode D4 serves as an output voltage VPUMP.

The switch, which is implemented by the transistor M2, in the selection circuit is connected in parallel with the diode D4. In other words, when the transistor M2 is conducted, the diode D4 is bypassed, so the voltage conversion rate of the charge pump circuit becomes a lower value, such as 2 times. When the transistor M2 is not conducted, the diode D4 is not bypassed, so the voltage conversion rate of the charge pump circuit remains a higher value, such as 3 times.

The operating voltage generation circuit 232 comprises a Zener diode ZD, a resistor r1, and a transistor M1. The resistor r1 is connected between a first end n1 of the current mirror circuit 231 and a cathode of the Zener diode ZD. The reference current source Ith is connected to a second end n2 of the current mirror circuit 231. The current mirror circuit 231 mirrors the first current flowing through the first end n1 to generate a mirrored current at the second end n2. The mirrored current and the first current are designed to have a proportional relationship, such as 1:1 in this embodiment. The first current corresponds to the current IZD flowing through the Zener diode ZD.

Upon power-up, when the input voltage VIN gradually increases from 0 and remains below a breakdown voltage of the Zener diode ZD, the Zener diode ZD does not enter the breakdown state, and thus the Zener diode 121 is not conducted, and the current IZD is negligible. As a result, the operating voltage VDD is equal to the input voltage VIN minus the threshold voltage of transistor M1 and varies with the input voltage VIN. Since the current IZD is negligible, the mirrored current is also small and lower than the current of the reference current source Ith. Consequently, the voltage at the second end n2 is at a logic low level to turn off the switch (that is, the transistor M2), so that the diode D4 is not bypassed, and the voltage conversion rate of the charge pump circuit remains unchanged and is set to a higher value.

When the input voltage VIN exceeds the breakdown voltage of the Zener diode ZD, the Zener diode ZD enters the breakdown state (that is, the Zener diode 121 is turned on), so the current IZD increases significantly and the gate voltage of transistor M1 is clamped at the breakdown voltage of the Zener diode ZD. As a result, the operating voltage VDD is equal to the breakdown voltage of the Zener diode ZD minus the threshold voltage of transistor M1 and no longer varies with the input voltage VIN. Since the current IZD increases significantly, the mirrored current also increases and exceeds the current of the reference current source Ith. Consequently, the voltage at the second end n2 is at a logic high level to turn on the switch (that is, the transistor M2), so that the diode D4 is bypassed, and the voltage conversion rate of the charge pump circuit is lowered.

According to the above description, the user can design an appropriate reference current source Ith, so that the charge pump circuit is operated in a higher voltage conversion rate when the Zener diode ZD is not turned on and the operating voltage VDD is low, and is operated in a lower voltage conversion rate when the Zener diode ZD is turned on and the operating voltage VDD is high, so that the output voltage VPUMP of the charge pump circuit can be kept within the preset range. For example, when the input voltage range varies from 2.8V to 20V, the operating voltage VDD can be in a range of 2.3V to 5V and the voltage conversion rate of the charge pump circuit can be switched to 2 or 3.

In an embodiment, when the voltage conversion circuit is designed with more than two selectable voltage conversion ratios, such as three or four ratios, the aforementioned reference current source can include reference current sources for providing reference currents of different magnitudes. The selection circuit can include NOR logic gates and switches, so that the selection circuit can adjust the voltage conversion ratio of the voltage conversion circuit in multiple levels based on whether a mirrored current, which corresponds to a current I_ZD flowing through the Zener diode ZD, is respectively greater than the reference currents. For example, in an embodiment, the selection circuit includes a first switch connected in parallel with a diode D3, and a second switch connected in parallel with a diode D4. The mirrored current is compared with a first reference current and a second reference current, respectively. A first NOR gate receives a comparison result for the first reference current to control the first switch, and a second NOR gate receives a comparison result for the second reference current to control the second switch, thereby enabling multi-level adjustment of the voltage conversion ratio.

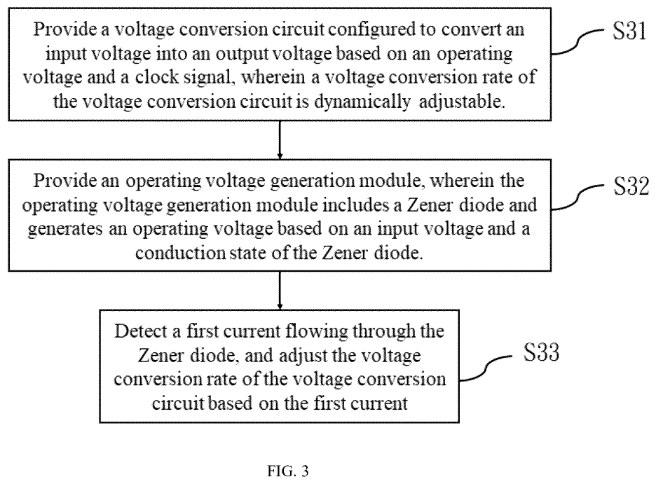

Please refer to FIG. 3, which is a flowchart of the voltage conversion method of the present invention. As shown in FIG. 3 and FIG. 1, the voltage conversion method of the present invention can comprise the following steps.
Step S31: a voltage conversion circuit 11 is provided, the voltage conversion circuit 11 converts an input voltage 141 into an output voltage 112 based on an operating voltage 140 and a clock signal 142, and a voltage conversion ratio 111 of the voltage conversion circuit 11 is dynamically adjustable. In an embodiment, the voltage conversion circuit 11 can be a charge pump circuit or a switched capacitor power conversion circuit.
Step S32: an operating voltage generation module 12 is provided, the operating voltage generation module 12 comprises a Zener diode 121, and generates the operating voltage 140 based on the input voltage 141 and a conduction state of the Zener diode 121.
Step S33: a first current flowing through the Zener diode 121 is detected, and the voltage conversion ratio 111 of the voltage conversion circuit 11 is adjusted based on the first current.

In an embodiment of Step S33, when the first current is greater than a reference current, the voltage conversion ratio 111 is set to a lower value; and when the first current is not greater than the reference current, the voltage conversion ratio 111 is set to a higher value.

In another embodiment of Step S33, the method further comprises steps of providing a reference current source for generating a reference current; and providing a current mirror circuit having a first end coupled to the Zener diode 121 to make a first current flow through the first end, and a second end coupled to the reference current source. The current mirror circuit 121 mirrors the first current to generate a second current flowing through the second end. A voltage of the second end is used to adjust the voltage conversion ratio 111 of the voltage conversion circuit 11.

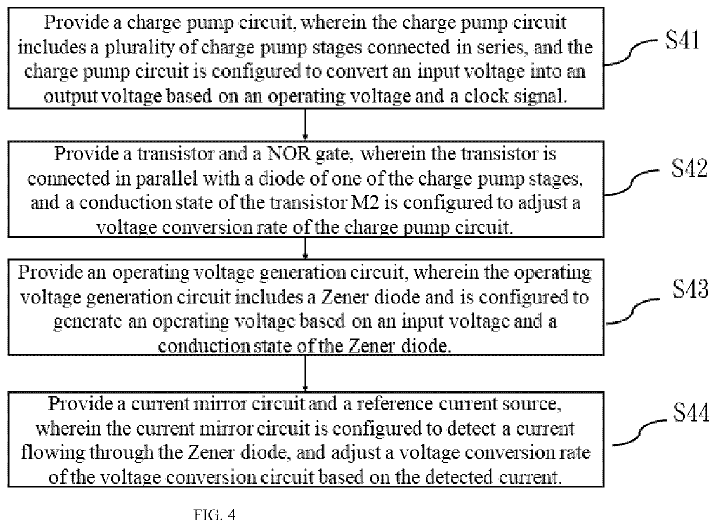

Please refer to FIG. 4, which is a flowchart illustrating one embodiment of the voltage conversion method of the present invention. As shown in FIG. 4 and FIG. 2, the embodiment of the voltage conversion method may comprise the following steps.
Step S41: a charge pump circuit comprising a plurality of charge pump stages connected in series is provided. The charge pump circuit converts an input voltage VIN into an output voltage VPUMP based on an operating voltage VDD and a clock signal CLK.
Step S42: a transistor M2 and a NOR gate are provided. The transistor M2 is connected in parallel with a diode D4 of one of the charge pump stages. A conduction state of the transistor M2 adjusts a voltage conversion ratio of the charge pump circuit. For example, when the transistor M2 is turned on, the diode D4 is bypassed, resulting in a decrease in the voltage conversion ratio of the charge pump circuit. When the transistor M2 is turned off, the diode D4 is not bypassed, and the voltage conversion ratio remains unchanged.
Step S43: an operating voltage generation circuit 232 is provided. The operating voltage generation circuit 232 comprises a Zener diode ZD, a resistor r1, and a transistor M1. The operating voltage generation circuit 232 generates an operating voltage VDD based on an input voltage VIN and a conduction state of the Zener diode ZD. For example, when the Zener diode ZD is not conducted (that is, the Zener diode ZD is not in the breakdown state), the operating voltage VDD is equal to the input voltage VIN minus a threshold voltage of the transistor M1. When the Zener diode ZD is conducted (that is, the Zener diode ZD is in a breakdown state), the operating voltage VDD is determined by subtracting the threshold voltage of transistor M1 from the Zener diode's breakdown voltage.
Step S44: a current mirror circuit 231 and a reference current source Ith are provided for detecting a current I_ZD flowing through the Zener diode ZD, and adjusting the voltage conversion ratio 111 of the voltage conversion circuit 11 based on the current I_ZD. In this embodiment, the resistor r1 is connected between a first end n1 of the current mirror circuit 231 and a cathode of the Zener diode ZD. The reference current source Ith is connected to a second end n2 of the current mirror circuit 231. The current mirror circuit 231 mirrors a first current flowing through the first end n1 to generate a mirrored current at the second end n2. The mirrored current and the first current are in a predetermined proportional relationship, which is 1:1 for explanation in this embodiment. The first current is the current I_ZD flowing through the Zener diode ZD.
Step S45: the switch (that is, the transistor M2) is selectively activated to bypass the corresponding charge pump stage based on whether the Zener diode ZD current exceeds the current of the reference current source, thereby adjusting voltage conversion ratio of the charge pump circuit.

In this embodiment, during a period in which the input voltage VIN is not greater than the breakdown voltage of the Zener diode ZD, the Zener diode ZD is not in a breakdown state (that is, Zener diode ZD is not conducted), the current I_ZD is very small and negligible, so the operating voltage VDD is equal to the input voltage VIN minus the threshold voltage of the transistor M1 and varies with the input voltage VIN. Since the current I_ZD is negligible, the mirrored current is also very small and less than the current of the reference current source Ith. Consequently, the voltage at the second end n2 is at a logic low level, thereby deactivating the switch (that is, the transistor M2). As a result, the diode D4 is not bypassed, and the voltage conversion ratio of the charge pump circuit remains unchanged, that is, the voltage conversion ratio is set as a higher value.

When the input voltage VIN is greater than the breakdown voltage of the Zener diode ZD, the Zener diode ZD enters the breakdown state (that is, the Zener diode ZD is conducted), the current I_ZD significantly increases and a gate voltage of the transistor M1 is clamped at the breakdown voltage of the Zener diode ZD, so the operating voltage VDD is equal to the breakdown voltage of the Zener diode ZD minus the threshold voltage of the transistor M1 and does not vary with the input voltage VIN. As the current I_ZD significantly increases, the mirrored current becomes larger and exceeds the current of the reference current source Ith, so the voltage at the second end n2 reaches a logic high level to turn on the switch (that is, the transistor M2), so the diode D4 is bypassed and the voltage conversion ratio of the charge pump circuit is affected to decrease, that is, the voltage conversion ratio of the charge pump circuit becomes a lower value.

Although the present invention has been described with reference to the foregoing embodiments, these embodiments are not intended to limit the present invention. Any person skilled in the art may make modifications and adjustments without departing from the spirit and scope of the present invention. Therefore, the scope of protection of the present invention shall be defined by the appended claims.

What is claimed is:

1. A voltage conversion device, comprising:
a voltage conversion circuit, configured to convert an input voltage into an output voltage based on an operating voltage and a clock signal, wherein a voltage conversion rate of the voltage conversion circuit is dynamically adjustable;
an operating voltage generation module, comprising a Zener diode, and configured to generate the operating voltage based on the input voltage and a conduction state of the Zener diode; and
a processing module, connected to the operating voltage generation module and configured to detect a first current flowing through the Zener diode and adjust the voltage conversion rate of the voltage conversion circuit based on the first current.

2. The voltage conversion device of claim 1, wherein when the first current is higher than a reference current, and the processing module sets the voltage conversion rate of the voltage conversion circuit to a lower value.

3. The voltage conversion device of claim 2, wherein when the first current is not higher than the reference current, the processing module sets the voltage conversion rate of the voltage conversion circuit to a higher value.

4. The voltage conversion device of claim 2, wherein the processing module comprises a current mirror circuit and a reference current source, the reference current source is configured to generate the reference current, a first end of the current mirror circuit is coupled to the Zener diode to make the first current flow through the first end, a second end of the current mirror circuit is coupled to the reference current source, and the current mirror circuit is configured to mirror the first current to generate a second current flowing through the second end, wherein a voltage at the second end is used to set the voltage conversion rate of the voltage conversion circuit.

5. The voltage conversion device of claim 1, wherein the voltage conversion circuit comprises a charge pump circuit, and the charge pump circuit comprises charge pump stages connected in series, the processing module comprises a switch and a logic circuit, the switch is connected in parallel with a corresponding one of the charge pump stages, and the logic circuit is configured to selectively turn on the switch to bypass the corresponding one of the charge pump stages, thereby adjusting the voltage conversion rate of the charge pump circuit.

6. The voltage conversion device of claim 2, wherein the reference current comprises reference currents, and the processing module is configured to adjust the voltage conversion rate of the voltage conversion circuit in multiple stages based on whether the first current is higher than each of the reference currents.

7. A voltage conversion method, comprising:
providing a voltage conversion circuit to convert an input voltage into an output voltage based on an operating voltage and a clock signal, wherein a voltage conversion rate of the voltage conversion circuit is dynamically adjustable;
wherein the operating voltage generation module comprises a Zener diode and configured to generate the operating voltage based on the input voltage and a conduction state of the Zener diode; and
detecting a first current flowing through the Zener diode, and adjusting the voltage conversion rate of the voltage conversion circuit based on the first current.

8. The voltage conversion method of claim 7, wherein adjusting the voltage conversion rate of the voltage conversion circuit based on the first current comprises:
setting the voltage conversion rate of the voltage conversion circuit to a lower value when the first current is higher than a reference current; and
setting the voltage conversion rate of the voltage conversion circuit to a higher value when the first current is not higher than the reference current.

9. The voltage conversion method of claim 8, further comprising:
providing a reference current source to generate the reference current; end of the current mirror circuit is coupled to the Zener diode such that the first current flows through the first end, a second end of the current mirror circuit is coupled to the reference current source, and the current mirror circuit is configured to mirror the first current to generate a second current flowing through the second end; and
adjusting the voltage conversion rate of the voltage conversion circuit based on a voltage at the second end of the current mirror circuit.

10. The voltage conversion method of claim 9, wherein the voltage conversion circuit comprises a charge pump circuit, and the charge pump circuit comprises a plurality of charge pump stages connected in series, and the voltage conversion method further comprises:
one of the charge pump stages; and
selectively turning on the switch based on whether the first current is higher than the reference current to bypass the corresponding one of the charge pump stages, thereby adjusting the voltage conversion rate of the charge pump circuit.
